(19) United States
(12) Patent Application Publication
(10) Pub. No.: US 2005/0066539 A1
(43) Pub. Date: Mar. 31, 2005

(54) Electrocapillary cleaning aids in dishwashers

(76) Inventors: Bernd Janocha, Wiesbaden (DE); Heinrich Malthaner, Stuttgart (DE); Dieter Renzow, Rutesheim (DE); Dirk Hegemann, Sutherland (CH); Rudiger Eiermann, Syrgenstein (DE)

Correspondence Address: HARNESS, DICKEY & PIERCE, P.L.C., P.O. BOX 828, BLOOMFIELD HILLS, MI, 48303, US

(21) Appl. No.: 10/484,867

(22) PCT Filed: Jul. 23, 2002
(86) PCT No.: PCT/EP02/08171

(30) Foreign Application Priority Data
Jul. 28, 2001 (DE) 101 36 937.9

(51) Int. Cl. F26B 3/34

(52) U.S. Cl. 34/250

(57) ABSTRACT

The invention relates to a method for cleaning objects (3), particularly kitchenware (3), whereby the objects to be cleaned (3) are brought in contact with a washing liquid (5).

According to the invention, at least one electric field is generated in at least some parts of the surface of the objects to be cleaned (3).

The present invention relates to a method for cleaning objects, particularly kitchenware, whereby the objects to be cleaned are brought in contact with a washing liquid. Moreover, the present invention relates to an apparatus for cleaning objects, particularly a dishwashing machine, that brings the objects to be cleaned in contact with a washing liquid.

During recent years, a number of technical improvements have been developed for dishwashing machines and such improved machines have been brought on the market. For example, the energy consumption per average dishwashing cycle has been reduced from 3.1 kWz in 1965 to 1.05 kWh today. Moreover, water consumption has been reduced from 60 to 12 L and detergent consumption from 40 to 25 g.

The object of the present invention is to further develop the methods and equipment of the said kind so as to provide further savings in machinery, energy consumption and/or water and/or detergent while at the same time shortening the cleaning time without impairing the cleaning results.

This objective can be reached through the features indicated in the independent claims.

The method according to the invention is based on the prior art of the said kind in that an electric field is created in at least some areas of the surfaces of the objects to be cleaned, said field being imparted by the washing liquid. This, on the one hand, brings about faster initial dissolution of the soil present on the objects to be cleaned, for example on glass and/or porcelain and, on the other, the soil is dislodged from a larger surface area. By this effect, the same cleaning efficiency compared to the prior art can be achieved in a more effective manner and with a reduced consumption of water and/or energy and/or detergents. The electric field is preferably an electrostatic field the generation of which requires no flow of electric current or requires only a very minor flow. The invention uses the physical and chemical effects of electrocapillarity, particularly electrically induced preferential wetting and electrosorption, which together are here referred to as electrocapillary cleaning assistance. The assumed mechanism of electrocapillarity is the mutual repulsion, at the interface, of charge carriers carrying charges of the same sign. By electrically induced preferential wetting is meant the influencing of the surface tension of liquids by an electric field. By electrosorption is meant the influencing of adsorption or desorption of adsorbate molecules at the solid-water interfaces by an electric field acting perpendicularly to the interfaces. A combination of these two physical and chemical effects is, for example, the influencing of electrically induced preferential wetting by surfactants. For example, the curves showing electrically induced preferential wetting as a function of electric potential can be strongly influenced by the addition of surfactants having cleaning activity.

According to the method of the invention, the electric field preferably has a component that is perpendicular to the surfaces of the objects to be cleaned. If the washing liquid contains surfactants, this component can be substantially smaller than required by the theory of electrocapillarity for a liquid devoid of surfactants.

In particularly preferred embodiments of the method of the invention, the electric field is generated by electrification of the washing liquid. In this case, the physical background of electrocapillary cleaning assistance lies in the fact that at the interface between the washing liquid, particularly an aqueous solution, and the objects to be cleaned, the electric field reduces the surface tension of the washing liquid thus improving the wetting on the surfaces of the objects to be cleaned (electrically induced preferential wetting). If the washing liquid contains surfactants, they can be guided by the electric field selectively to the surfaces of the objects to be cleaned (electrosorption).

Moreover, in preferred embodiments of the method of the invention the washing liquid contains substances with cleaning ability, particularly surfactants and/or enzymes. Because of the electric field, the substances with cleaning ability can be guided rapidly to the objects to be cleaned, resulting in more effective soil removal. If soil is removed at one spot, the washing liquid with its reduced surface tension can by electrocapillarity penetrate more readily between the objects to be cleaned and the soil, so that the soil is displaced more effectively.

Furthermore, in advantageous embodiments of the method of the invention the electrification of the washing liquid occurs by means of a first electrode to which is applied an electric potential. The washing liquid is thus electrified regardless of the presence of dissolved additives. The presence of substances with cleaning ability and particularly of surface-active substances, however, was found to be very advantageous for the cleaning.

The method of the invention uses an electric potential in the range from 100 volts to 10,000 volts and particularly from 1000 volts to 5,000 volts. The polarity of the potential can be either positive or negative. A possible charge on ionic surfactants should therefore be the same as the charge on the electrified washing liquid. The current can be either direct or alternating.

Furthermore, in preferred embodiments of the method of the invention, the electrification electrode is disposed in the region of a section of the line through which the washing liquid flows before it comes in contact with the objects to be cleaned. In particular, the electrode can be a metallic electrode.

As regards the method of the invention, the electrification electrode can also be disposed in the region of a nozzle arm. In this case, for example, a high voltage can be applied directly to a conductive nozzle that is electrically insulated in a suitable manner.

In this respect in particular, by the method of the invention a counterelectrode can be disposed close to the objects to be cleaned. The electric field then decreases between the electrified washing liquid and the counterelectrode. Embodiments are also possible, however, wherein the counterelectrode is omitted, in which case the metallic objects present in the vicinity, for example the boundary of the inner cleaning space, can act as the counterelectrode.

Moreover, by the method of the invention the washing liquid, after coming in contact with the objects to be cleaned, can be collected in a collecting container. As is known, for example, for dishwashing machines, the washing liquid can be recycled by pumping for at least a length of time so that it can repeatedly be brought in contact with the objects to be cleaned.

Furthermore, by the method of the invention the washing liquid, after having at least once come in contact with the objects to be cleaned, can be de-electrified at least in part. If the washing liquid is recycled by pumping so as to be repeatedly brought in contact with the objects to be cleaned, it can be advantageous for the de-electrification to occur only after the last contact with the objects to be cleaned has occurred.

In connection with the foregoing, in particular, by the method of the invention the washing liquid can be at least partly de-electrified before it is disposed of. By disposal is meant in this respect, for example, the final removal of the washing liquid by pumping it out of the dishwashing machine.

In preferred embodiments of the method of the invention, the de-electrification occurs with the aid of a de-electrification electrode. This electrode is preferably connected to a mass to permit a preferably complete electric discharge of the washing liquid.

In the afore-explained context, in particular, in certain preferred embodiments of the method of the invention, the de-electrification electrode can be located in the region of the collecting container.

Any apparatus that is suitable for carrying out an embodiment the method of the invention falls under the protective scope of the related claims.

The apparatus according to the invention is based on the prior art of this kind in that it is provided with means that generate an electric field at least in some regions of the surfaces of the objects to be cleaned. In this manner, on the one hand, the soil on the objects to be cleaned, for example on glass and/or porcelain, begins to dissolve more quickly and, on the other, the removal of soil from a larger surface area is achieved, as described for the method of the invention. By these two effects, the same cleaning efficacy as that shown by the known equipment of the same kind is achieved more rapidly and with a lower consumption of water and/or energy and/or cleaning agent. In this case, too, the electric field is preferably an electrostatic field the generation of which requires no flow of electric current or requires only a very minor flow. The apparatus according to the invention thus makes use of the physical and chemical effects of electrically induced preferential wetting and electrosorption which together, as previously stated, are also referred to as electrocapillary cleaning assistance. The assumed mechanism of electrocapillarity is the mutual repulsion, at the interface, of charge carriers carrying charges of the same sign. By electrically induced preferential wetting is meant the influencing of the surface tension of liquids by an electric field. By electrosorption is meant the electric potential-dependent influencing of adsorption or desorption of adsorbate molecules at solid-water interfaces. A combination of these two physical and chemical effects is, for example, the influencing of electrically induced preferential wetting by surfactants, as previously explained for the method of the invention. For example, in the case of the apparatus of the invention, too, the curves of electrically induced preferential wetting as a function of electric potential can be strongly influenced by the addition of surfactants showing cleaning activity.

Moreover, in the apparatus of the invention, the electrification means preferably generate an electric field over the surfaces of the objects to be cleaned in a manner such that said field has a vertical component over the objects to be cleaned.

In particularly preferred embodiments of the apparatus of the invention, the electrifying means electrify the washing liquid. In this case, the physical background of electrocapillary cleaning assistance consists in that the electric field, at the interface between the washing liquid particularly water, and the objects to be cleaned reduces the surface tension of the washing liquid thus improving the wetting on the surfaces of the objects to be cleaned (electrically induced preferential wetting), as previously indicated for the method of the invention. If the washing liquid contains surfactants, then in the case of the apparatus of the invention, too, they can be guided by the electric field to the surfaces of the objects to be cleaned (electrosorption).

Furthermore, in the preferred embodiments of the apparatus according to the invention, the washing liquid contains substances with cleaning activity, particularly surfactants and/or enzymes. The substances with cleaning ability can, because of the electric field, be guided rapidly to the objects to be cleaned, resulting in a more rapid soil removal. If soil is removed at one spot, the washing liquid with a reduced surface tension can penetrate more readily between the objects to be cleaned and the soil, so that the soil is more effectively displaced. This has already been explained in connection with the method of the invention.

In advantageous embodiments of the apparatus of the invention, the means for electrifying the washing liquid comprise an electrification electrode to which an electric potential can be applied. The washing liquid is thus electrified regardless of the presence of dissolved additives. The presence of substances with cleaning ability and particularly of surface-active substances, however, was found to be very advantageous for the cleaning, as already indicated in connection with the method of the invention.

Moreover, it is also preferred that the positive or negative electric potential for the apparatus of the invention be in the range from 100 to 10,000 volts and particularly from 1000 to 5,000 volts. In this case, too, the current can be direct or alternating current.

Furthermore, in a preferred embodiment of the apparatus of the invention, the electrifying electrode is disposed in the region of a section of the line through which the washing liquid flows before said washing liquid comes in contact with the objects to be cleaned. In this case, too, the electrode can, in particular, be a metallic electrode.

With respect to the apparatus of the invention, too, the electrification electrode can also be disposed in the region of a nozzle arm. In this case, for example, as has already been explained in connection with the method of the invention, a high voltage can be applied directly to a conductive nozzle that is electrically insulated in a suitable manner.

In this respect in particular, in the apparatus of the invention a counterelectrode can be disposed close to the objects to be cleaned. Embodiments are also possible, however, wherein the counterelectrode is omitted, in which case the metallic objects present in the vicinity, for example the boundary of the inner cleaning space, can act as the counterelectrode, as has already been explained for the method of the invention.

Furthermore, in the apparatus of the invention the washing liquid, after coming in contact with the objects to be cleaned, can be collected in a collecting container. As is known, for example, for dishwashing machines, the washing liquid can, as indicated, be recycled by pumping for a certain period of time so that it can repeatedly be brought in contact with the objects to be cleaned.

Moreover, the apparatus of the invention can be provided with a de-electrification electrode for the purpose of at least partially de-electrifying the washing liquid after said liquid has at least once come in contact with the objects to be cleaned. In the event that the washing liquid is recycled by pumping so as to be brought repeatedly into contact with the objects to be cleaned, it can be advantageous also in the case of the apparatus of the invention to undertake the de-electrification only after the last contact with the objects to be cleaned has occurred.

Furthermore, in the afore-explained regard in particular, in the apparatus of the invention the de-electrification means will at least partially de-electrify the washing liquid before said washing liquid is disposed of. By disposal is meant in this regard, too, the final removal of the washing liquid by pumping it out of the dishwashing machine.

In the preferred embodiments of the apparatus of the invention, too, the de-electrification means comprise a de-electrifying electrode. Said electrode is preferably connected to a mass to permit a preferably complete electric discharge of the washing liquid, as in the case of the method of the invention.

In regard to the afore-explained context, in certain embodiments of the apparatus of the invention the de-electrifying electrode can be located in the region of the collecting container.

Furthermore, in the preferred embodiments of the apparatus of the invention there is provided a protective circuit breaker that turns off the power in the event of a predetermined current flow. In this case, the predetermined current flow is selected so that the power is shut off before reaching a level dangerous for humans.

In the following, the invention will be explained by reference to the attached drawings in which:

FIG. 1 is a schematic representation of the operating principle of the electrocapillary cleaning effect;

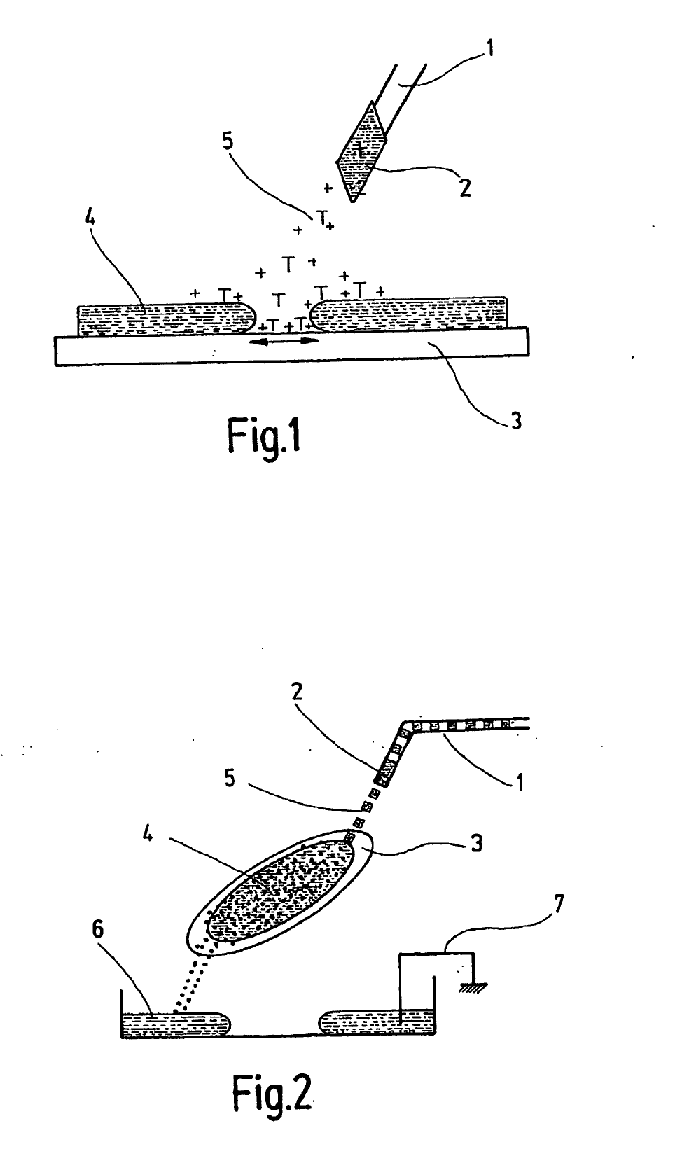

FIG. 2 is a schematic representation of a first embodiment of the apparatus of the invention that is also suitable for carrying out the method of the invention;

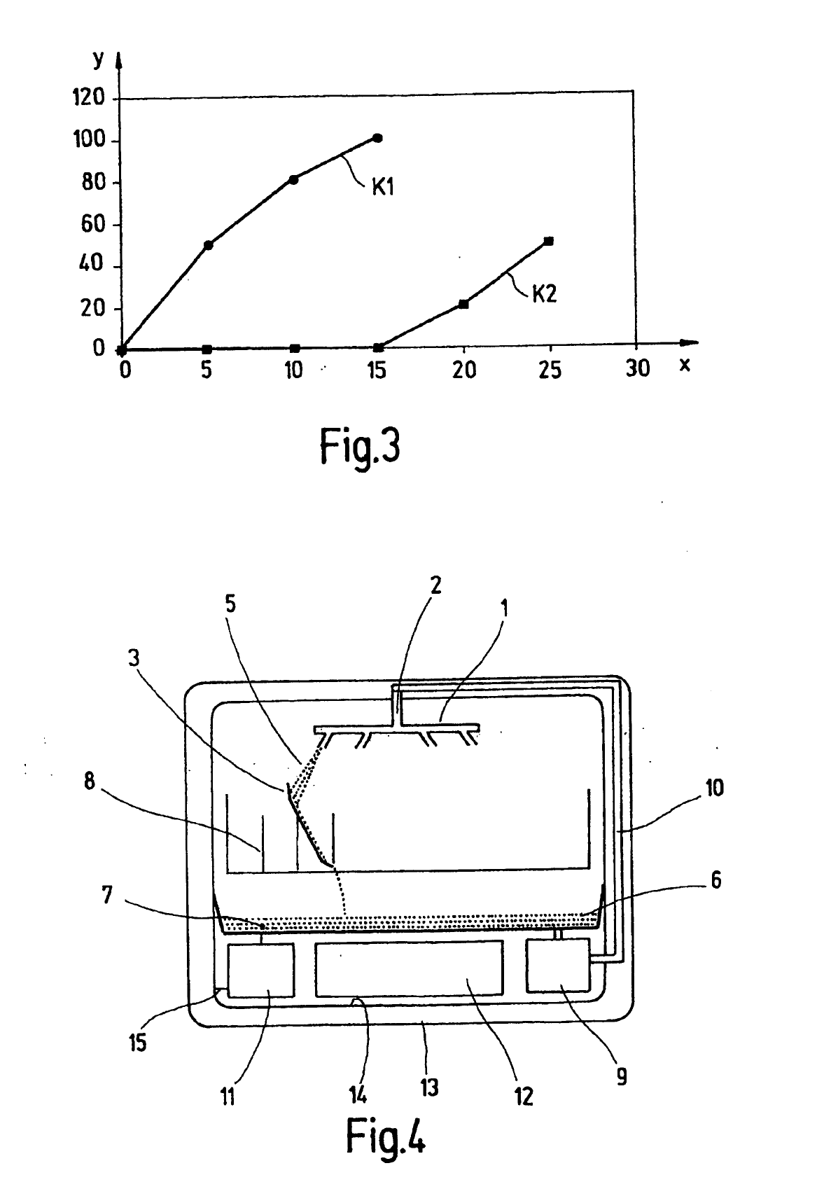

FIG. 3 shows two curves illustrating, for an electrified and a nonelectrified washing liquid, the dislodgement of a test soil from objects to be cleaned; and

FIG. 4 is a schematic representation of a second embodiment of the apparatus of the invention in the form of a dishwashing machine.

FIG. 1 shows a schematic representation of the operating principle of the electrocapillary cleaning effect, here with positive charge carriers (+) and surfactant molecules (T). According to the representation in FIG. 1, the washing liquid (for example water and cleaning agent) flowing out of a pipe 1 is electrified by an electrification electrode in the form of a bare metallic electrode 2. Some of the soil 4 on the objects to be cleaned 3 is dissolved more readily, because surfactant T is more effectively guided to soil 4. The washing liquid can more readily enter the interface and lift the soil 4 by penetrating under its surface. Necessary for the appearance of the effect of electrocapillary cleaning assistance is an electric field, particularly one that has a component perpendicular to the surface to be cleaned. This component can, in the presence of surfactant T, be substantially smaller than required by the theory of electrocapillarity for bringing about an effect in the absence of a surfactant T. It is possible in this manner to achieve cleaning assistance regardless of the kind of the counterelectrode, not shown in FIG. 1. Such a counterelectrode (not shown in FIG. 1) can be implemented selectively in the vicinity of the objects to be cleaned 3, but it can also be omitted, in which case the metallic objects present in the vicinity, for example the boundary of the internal cleaning space, can act as the counterelectrode. Because there is preferably no appreciable current flow, the objects acting as the counterelectrode do not have to be electrically connected to the high-voltage source. The flow of washing liquid between the nozzle acting as first electrode 2 and the objects to be cleaned 3 does not have to be continuous, because the electrified, charged washing liquid retains its charge even without contact with the electrifying electrode 2. Preferably, the electrified washing liquid is electrically discharged before it is removed from the inner space.

FIG. 2 shows a schematic representation of a first embodiment of the apparatus of the invention which is also suitable for carrying out the method of the invention. Such an apparatus was used to show the improvement in cleaning action as a result of the use of electrocapillary cleaning assistance on porcelain dishes soiled with a mixture of oatmeal gruel and starch. To this end, the dishes 3 in the apparatus shown in FIG. 2 were sprayed with electrified or with nonelectrified washing liquid. The washing liquid emerged from pipe 1 and was electrified with the aid of an electrification electrode in the form of a metallic electrode 2. The objects to be cleaned were porcelain dishes 3 to which had been applied a defined soil of oatmeal gruel and starch 4. The solution was collected in a collecting container 6 into which was immersed a grounded de-electrification electrode in the form of a metallic electrode 7. At varying times, the size of the areas from which soil film 4 had been removed was measured.

FIG. 3 shows two curves illustrating the removal of a test soil 4 from the objects to be cleaned 3 for an electrified and a nonelectrified washing liquid. The apparatus shown in FIG. 2 was used for this test under conditions explained in the foregoing. The size of the surface area from which the soil had been removed was measured as a function of time.

In FIG. 3, the relative soil removal in percent is plotted along the Y axis, with 100% corresponding to complete cleaning, while the time in minutes is plotted along the X axis. Curve K1 shows the cleaning results for an electrified washing liquid, whereas curve K2 shows the cleaning results for a nonelectrified washing liquid according to the prior art, referring to the apparatus of FIG. 2. Curve K1 refers to the case of a washing liquid electrified with 3500 volts. A comparison of curves K1 and K2 shows clearly that by generating an electric field according to the invention, much better cleaning results were obtained in a much shorter time.

By the present invention and based on the prior art, additional savings in operating resources (time, energy, water, cleaning agent) can be achieved, particularly for dishwashing machines. For example, spray nozzles 1 of a dishwashing machine can be provided with a high voltage which will result in electrification of the washing liquid 5 used. No special washing liquid is needed for this purpose. The rotation of nozzle arm 1 which is common for dishwashing machines and thus the pulsed spraying onto individual dish regions will bring about mechanical removal of the dislodged soil 4 without negatively affecting the electrocapillary cleaning assistance. This effect can be further enhanced by the temperature of the washing liquid. The electric fields used according to the invention, particularly electrostatic fields, have high field strength, but the current flow is preferably so low that the resulting power level is harmless to humans. By limiting these electric fields, for example, to the inner washing space, and by the presence of a current-limiting device which will shut off the power when an appreciable current arises, the user is exposed to no adverse effects. Moreover, it is possible to provide parts supplied with high voltage, for example a collecting container 6 or an internal housing, with a de-electrification electrode 7 in the form of a leak resistor. Preferably, before being removed by pumping, the washing liquid is electrically discharged via the grounding means of the apparatus.

FIG. 4 shows a schematic representation of a second embodiment of the apparatus of the invention in the form of a dishwashing machine. According to the representation in FIG. 4, a nozzle arm 1 from which the washing liquid is supplied by pumping is provided with an electrification electrode 2 that is connected to a high-voltage generator 11 via an insulated high-voltage line 15. Positive or negative direct current or alternating current is supplied to electrification electrode 2. The electrified washing liquid 5 flows over the objects to be cleaned 3 held in an insulated rack 8. The washing liquid is collected in a collecting container 6 whence it is recycled to nozzle 1 by a pump 9 through an insulating plastic line 10 the liquid-filled parts of said pump preferably being electrically insulated. The collecting container is equipped with a de-electrification electrode in the form of a grounded leak resistor 7, the purpose of this electrode being to ensure a safe operation. Additional technical devices 12, known in and of themselves, of the dishwashing machine shown in FIG. 4 are insulated either from the electrified washing liquid or from the outer housing 13. Outer housing 13 is preferably grounded via a protective grounding contact and insulated from the electrified washing liquid 5. This is accomplished either in that the inner housing 14 of the dishwashing machine is made of a plastic material, or said inner housing 14 is a metallic housing that is electrically completely insulated from the outer housing 13 and/or from the washing liquid 5. Although this is not shown in the drawing, the electrification of washing liquid 5 can be carried out at a different point, for example by applying a high voltage to the dish rack. The washing liquid is electrified regardless of the presence of dissolved additives. The presence of cleaning agents containing surface-active substances, however, was found to be particularly advantageous for cleaning.

The foregoing description of embodiments of the present invention is provided only for illustrative purposes and is not intended to limit the invention. Various changes and modifications are possible within the framework of the invention without exceeding the scope of the invention or of the equivalents thereof.

1-30. (Cancelled).

31. A method for cleaning an object, the method comprising:
bringing the object to be cleaned in contact with a washing liquid; and
generating at least one electric field in at least a portion of a surface of the object to be cleaned.

32. The method according to claim 31, wherein the electric field has a perpendicular component over the surface of the objects to be cleaned.

33. The method according to claim 31, wherein the electric field is generated by one of a positive and a negative electrification of the washing liquid.

34. The method according to claim 31, wherein the washing liquid is electrified via an electrification electrode to which is applied an electric potential.

35. The method according to claim 31, wherein the positive or negative direct or alternating potential is in the range from 100 to 10,000 volts and particularly from 1000 to 5,000 volts.

36. The method according to claim 31, wherein the washing liquid contains substances with cleaning ability, particularly surfactants and/or enzymes.

37. The method according to claim 31, wherein the electrification electrode is disposed in a region of a section of a line through which the washing liquid flows before coming in contact with the objects to be cleaned.

38. The method according to claim 31, wherein the electrification electrode is disposed in the region of a nozzle arm.

39. The method according to claim 31, wherein a counter-electrode is disposed in the vicinity of the objects to be cleaned.

40. The method according to claim 31, wherein after coming in contact with the objects to be cleaned the washing liquid is collected in a collecting container.

41. The method according to claim 31, further comprising the step of at least partially de-electrifying the washing liquid after the step of bringing the object cleaned in contact with a washing liquid.

42. The method according to claim 31, further comprising the step of at least partially de-electrifying the washing liquid before the step of disposing the washing liquid.

43. The method according to claim 31, wherein the de-electrification is carried out with the aid of a de-electrification electrode.

44. The method according to claim 31, wherein the de-electrification electrode is disposed in the region of the collecting container.

45. An apparatus for carrying out the method according to claim 31.

46. An apparatus for cleaning objects which brings the objects to be cleaned in contact with a washing liquid, wherein the apparatus includes means capable of generating at least one electric field in at least some regions of the surfaces of the objects to be cleaned.

47. The apparatus according to claim 46, wherein the means generate the electric field so that said field has a perpendicular component over the surface of the objects to be cleaned.

48. The apparatus according to claim 46, wherein the means electrify the washing liquid.

49. The apparatus according to claim 16, wherein the washing liquid contains substances with cleaning ability, particularly surfactants and/or enzymes.

50. The apparatus according to claim 16, wherein the means for electrifying the washing liquid comprise an electrification electrode to which an electric potential can be applied.

51. The apparatus according to claim 16, wherein the positive or negative, direct or alternating potential is in the range from 100 to 10,000 volts and particularly from 1000 to 5,000 volts.

52. The apparatus according to claim 16, wherein the electrification electrode is disposed in the region of a section of the line through which the washing liquid flows before coming in contact with the objects to be cleaned.

53. The apparatus according to claim 16, wherein the electrification electrode is disposed in the region of a nozzle arm.

54. The apparatus according to claim 16, further comprising a counterelectrode disposed in the vicinity of the objects to be cleaned.

55. The apparatus according to claim 16, wherein metallic objects of the apparatus or metallic objects to be cleaned take over the function of the counterelectrode.

56. The apparatus according to claim 16, wherein, after having been brought in contact with the objects to be cleaned, the washing liquid is collected in a collecting container.

57. The apparatus according to claim 16, further comprising de-electrification means for the purpose of at least partially de-electrifying the washing liquid after said washing liquid has at least once been brought in contact with the objects to be cleaned.

58. The apparatus according to claim 16, wherein the de-electrification means de-electrify the washing liquid at least partially before said washing liquid is disposed of.

59. The apparatus according to claim 16, wherein the de-electrification electrode is located in the region of the collecting container.

60. The apparatus according to claim 16, further comprising a protective circuit breaker which shuts off the electric power when a pre-determined current flow is exceeded.

61. The apparatus according to claim 16, wherein the apparatus is a dishwasher.
